(19) United States
(12) Patent Application Publication
(10) Pub. No.: US 2005/0235076 A1
(43) Pub. Date: Oct. 20, 2005

(54) Targeted communications for microcode updates using dedicated LUNs

(76) Inventors: Daniel James Winarski, Tucson, AZ (US); Robert George Emberty, Tucson, AZ (US); Craig Anthony Klein, Tucson, AZ (US); Nils Haustein, Zornheim (DE)

Correspondence Address: Allen K. Bates;IBM Corporation - 90A/9032-1, 9000 South Rita Road, Tucson, AZ, 85744, US

(21) Appl. No.: 10/825,145

(22) Filed: Apr. 14, 2004

(51) Int. Cl. G06F 13/10

(52) U.S. Cl. 710/62

(57) ABSTRACT

Disclosed are a system, a method, and article of manufacture to provide for microcode updates for devices and libraries attached to Storage Area Networks. Exemplary embodiments include updating microcode residing in nonvolatile memory using Logical Unit Numbers assigned to specific storage components. Components receiving microcode updates include data storage devices, docking stations, removable hard disk drives, robotic accessors and library controllers.

### TECHNICAL FIELD

The present invention relates generally to network devices in a storage system, where each device has an I/O interface. More particularly, the invention relates to a novel system and method for managing communications using a dedicated Logical Unit Number address that is an integral subset of the I/O interface.

### BACKGROUND OF THE INVENTION

A common communication interface for open systems storage products is the Small Computer Systems Interface (SCSI) interface. Hard disk drives, optical disk drives, tape drives, and automated storage libraries which support SCSI are available from a majority of the computer system manufacturers. Small Computer Systems Interface (SCSI) protocol can also exist over a Fibre Channel (FC) physical layer. The SCSI interface identifies devices using Logical Unit Numbers (LUNs). Each SCSI interface has a minimum of eight LUNs while other SCSI interfaces may have more.

Storage automation products, such as the IBM 3584 Ultra Scalable Tape Library, provided by International Business Machines, the assignee of the present invention, may provide one or more Fibre Channel communications interfaces for devices within the library. The data storage drives included in the library may also provide Fibre Channel communications interfaces. An example of a data storage drive is a tape drive that is used to store and retrieve data with respect to magnetic tape. An example of a tape drive is the IBM TotalStorage® Enterprise Tape Drive 3592 manufactured by IBM Corporation. Tape drives are typically used in combination with an automated data storage library. For example the IBM TotalStorage® Enterprise Tape Library 3494 manufactured by IBM Corporation is an automated data storage library that may include one or more tape drives and data storage media for storing data with respect to the tape drives.

When a library has a problem, often the solution is that microcode needs to be updated or replaced in one or more devices within the library. Herein, the descriptor microcode and firmware are used interchangeably. For example, the robotic accessor which moves storage media between storage cells and the devices within the library may need an updated microcode to improve operation or correct an operational deficiency. In some cases the library controller may need a microcode update or replacement. It is important when updating the microcode to any component that the microcode is delivered to the correct component needing the update. Critical problems could result if microcode intended for one device within the library was inadvertently loaded into an incorrect device.

U.S. Pat. No. 6,434,090, “Automated Data Storage Library with Control Path to Shared Robotic Device via Media Drive,” discloses sending drive I/O commands using a specific LUN, for example, LUN-0, and sending robotic accessor commands using another LUN, for example, LUN-1, to load media into devices for the I/O commands sent to LUN-0. Updating of Microcode was not addressed by U.S. Pat. No. 6,434,090. Microcode updates are critical for the resolution of field problems and for the maintenance of the microcode within the library. Therefore there is a need to improve the updating of microcode in libraries and network attached storage.

### SUMMARY OF THE INVENTION

Broadly defined, the present invention provides a system and a method for updating microcode for a device using separate LUN addresses for the device and the memory where the microcode resides.

In method form, exemplary embodiments include a method for updating microcode comprising the steps of: assigning a first LUN to a first device; assigning a second LUN to a memory; the first device receiving one or more commands; the first device obtaining a LUN address from each of the one or more commands; and in response to the LUN address obtained from each of the one or more commands being equal to the second LUN, processing each of the one or more commands to update the microcode in the memory.

In system embodiments the present invention provides system for updating microcode, comprising: a first device addressable by a first LUN; and a memory addressable by a second LUN, wherein the first device receives one or more commands, obtains a LUN address from each of the one or more commands and in response to the LUN address obtained from each of the one or more commands being equal to the second LUN, processing each of the one or more commands to update the microcode in the memory.

These and other benefits of the present invention will be discussed in the following detailed description, which describes aspects of an exemplary system, apparatus, and procedure of the invention. It will be appreciated by those skilled in the art that although the following detailed description will proceed with reference being made to preferred embodiments and methods of use, the present invention is not intended to be limited to these preferred embodiments and methods of use. Rather, the present invention is intended to be limited only as set forth in the accompanying claims

For a more detailed understanding of the present invention, reference may be made to the following detailed description taken in conjunction with the accompanying drawings.

### BRIEF DESCRIPTION OF THE DRAWINGS

FIG. 1 is a block diagram that illustrates aspects of an exemplary storage area network (SAN).

FIG. 2 is a block diagram of a library controller which may implement the method of the present invention.

FIG. 3 illustrates an automated data storage library comprising a left hand service bay, multiple storage frames and a right hand service bay.

FIG. 4 illustrates a configuration of the automated data storage library of FIG. 3.

FIG. 5 illustrates an embodiment of an automated data storage library which employs a distributed system of processor nodes.

FIG. 6 illustrates a front and rear view of a data storage drive mounted in a drive canister.

FIG. 7 illustrates a docking station which accepts a removable media.

FIG. 8 illustrates removable media for storage of data.

FIG. 9 illustrates an interface with a plurality of LUNs.

FIG. 10 illustrates a SCSI write command for use with the present invention.

FIG. 11 is a flowchart showing one embodiment of a method for use with the present invention.

### DETAILED DESCRIPTION OF THE PREFERRED EMBODIMENTS

This invention is described in preferred embodiments in the following description. The preferred embodiments are described with reference to the Figures. While this invention is described in conjunction with the preferred embodiments, it will be appreciated by those skilled in the art that it is intended to cover alternatives, modifications, and equivalents as may be included within the spirit and scope of the invention as defined by the appended claims.

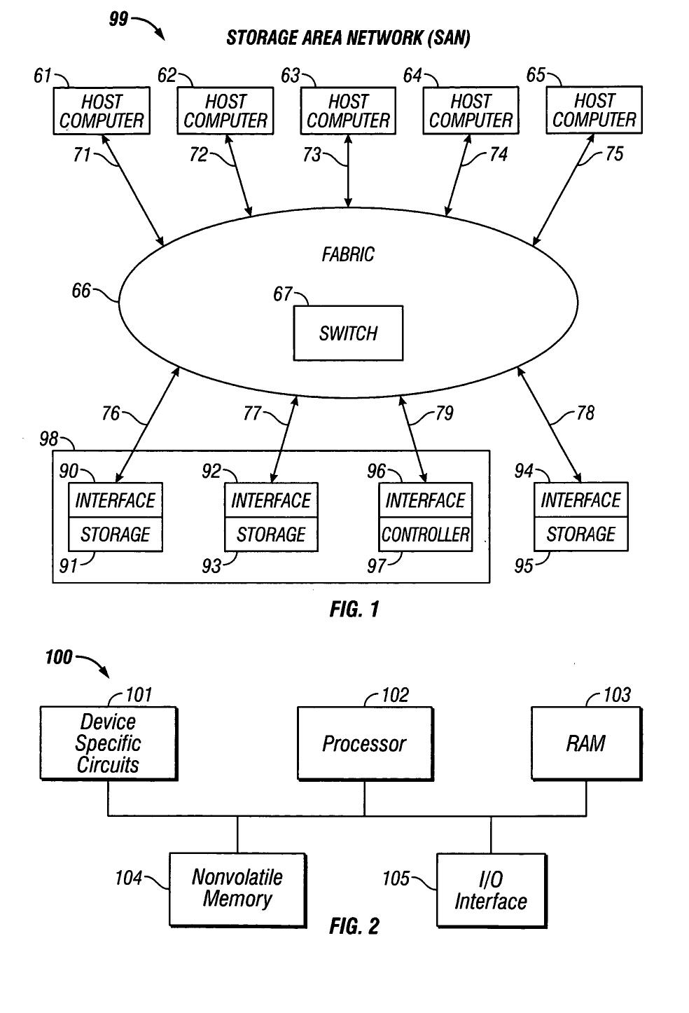

Referring to FIG. 1, there is shown a block diagram that illustrates aspects of an exemplary SAN 99, according to one embodiment of the present invention. In a preferred embodiment, SAN 99 is designed as a switched-access-network, wherein one of more FC switches 67 are used to create FC switching fabric 66. In one embodiment, SAN 99 is implemented using Small Computer Systems Interface (SCSI) protocol running over a Fibre Channel (FC) physical layer. SAN 99 could be implemented over other protocols, such as Infiniband, FICON, TCP/IP, Ethernet, Gigabit Ethernet, or iSCSI. In another embodiment, communication is implemented using Small Computer Systems Interface (SCSI) directly. All versions of SCSI are applicable, including SCSI-1, SCSI-2, FASTSCSI-2, WIDESCSI-2, ULTRA SCSI, ULTRAWIDE SCSI, ULTRA2 SCSI, and ULTRA3 SCSI. Each of these versions of SCSI support a minimum of eight Logical Unit Numbers (LUNs).

Host computers 61-65 are connected across I/O interfaces 71-75 respectively to fabric 66. I/O interfaces 71-75 may be any type of I/O interface; for example, a FC loop, a direct attachment to fabric 66 or one or more signal lines used by host computers 71-75 to transfer information respectively to and from fabric 66. Fabric 66 includes, for example, one or more FC switches 67 used to connect two or more computer networks. In one embodiment, FC switch 67 is a conventional router switch.

Switch 67 interconnects host computers 61-65 to storage 91, 93, and 95 and library controller 97 across respective communication links 76-79. Links 76-79 are preferably SCSI, iSCSI, or Fibre Channel which supports SCSI. Links 76-79 have a set of signal lines used by FC switch 67 to transfer information respectfully to and from storage 91, 93, and 95, and commands to and from library controller 97. I/O links 76-78 are connected to storage 91, 93, and 95 through interfaces 90, 92, and 94 respectively. Command link 79 is connected to library controller 97 via interface 96, respectively. Interfaces 90, 92, 94, and 96 are compatible with links 76-79 and are preferably SCSI, iSCSI or Fibre Channel which supports SCSI. As shown in FIG. 1, storage 91 and 93 are physically within automated data storage library 98, and storage 95 is physically outside of automated storage library 98. Storage 95 is typically network attached storage (NAS). Library controller 97, which is shown inside of library 98 in FIG. 1, may physically reside either inside or outside of library 98.

An automated data storage library typically comprises one or more controllers to direct the operation of the library. The controller may take many different forms and may comprise an embedded system, a distributed control system, a personal computer, workstation, etc. FIG. 2 shows a typical library controller 100 with a processor 102, RAM (Random Access Memory) 103, nonvolatile memory 104, device specific circuits 101, and I/O interface 105. Alternatively, the RAM 103 and/or nonvolatile memory 104 may be contained in the processor 102 as could the device specific circuits 101 and I/O interface 105. Processor 102 may comprise an off the shelf microprocessor, custom processor, FPGA (Field Programmable Gate Array), ASIC (Application Specific Integrated Circuit), discrete logic, etc. RAM (Random Access Memory) 103 is typically used to hold variable data, stack data, executable instructions, etc. The nonvolatile memory 104 may comprise any type of nonvolatile memory such as EEPROM (Electrically Erasable Programmable Read Only Memory), flash PROM (Programmable Read Only Memory), battery backup RAM, hard disk drive, etc. The nonvolatile memory 104 is typically used to hold the executable firmware and any nonvolatile data. I/O interface 105 comprises a communication interface that allows processor 102 to communicate with devices external to the controller. Examples of I/O interface 105 may comprise serial interfaces such as RS-232 or USB (Universal Serial Bus), SCSI (Small Computer Systems Interface), Fibre Channel, etc. In addition, I/O interface 105 may comprise a wireless interface such as RF or Infrared. The device specific circuits 101 provide additional hardware to enable the controller 100 to perform unique functions such as motor control of a cartridge gripper, etc. Device specific circuits 101 may comprise electronics that provide Pulse Width Modulation (PWM) control, Analog to Digital Conversion (ADC), Digital to Analog Conversion (DAC), etc. In addition, all or part of the device specific circuits 101 may reside outside controller 100.

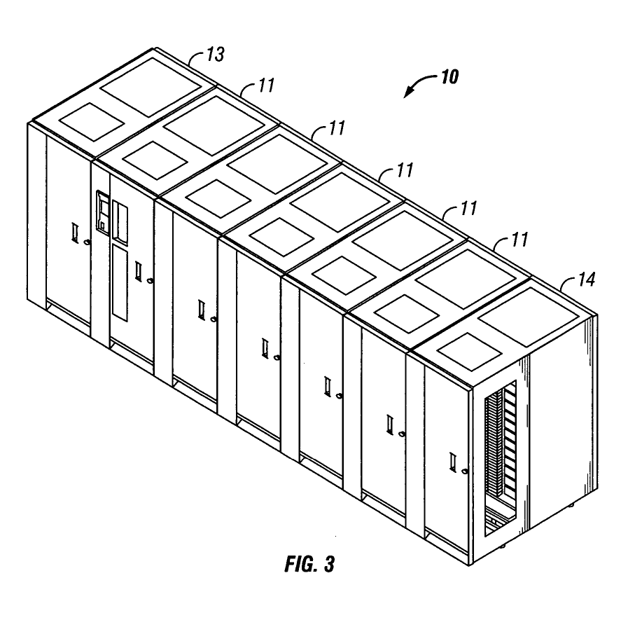

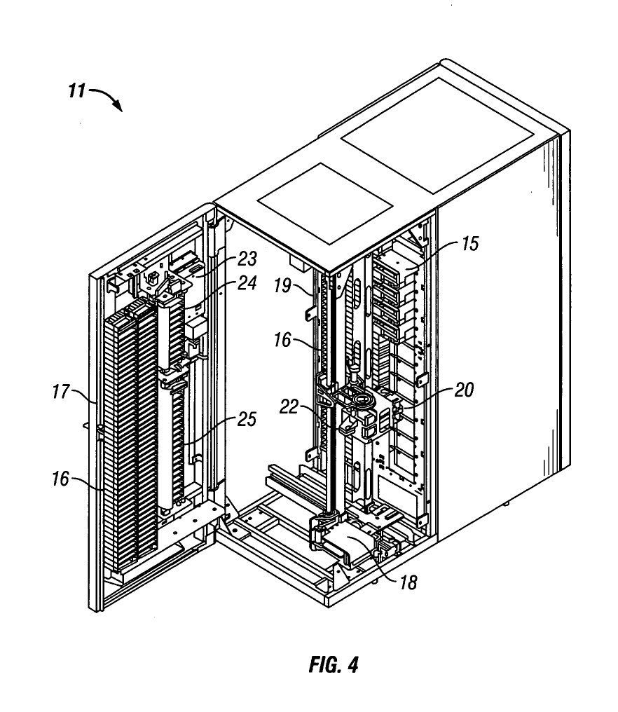

FIG. 3 illustrates an automated data storage library 10 with left hand service bay 13, one or more storage frames 11, and right hand service bay 14. As will be discussed, a frame may comprise an expansion component of the library. Frames may be added or removed to expand or reduce the size and/or functionality of the library. Frames may comprise storage shelves, drives, import/export stations, accessors, operator panels, etc. FIG. 4 shows an example of a storage frame 11, which also is the minimum configuration of the library 10 in FIG. 3. In this minimum configuration, there is no redundant accessor or service bay. The library is arranged for accessing data storage media (not shown) in response to commands from at least one external host system (not shown), and comprises a plurality of storage shelves 16, on front wall 17 and rear wall 19, for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18. As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or reading system, such as a smart card reader or similar system, mounted on the gripper 20, to “read” or “write” identifying information about the data storage media, for example, to a cartridge memory.

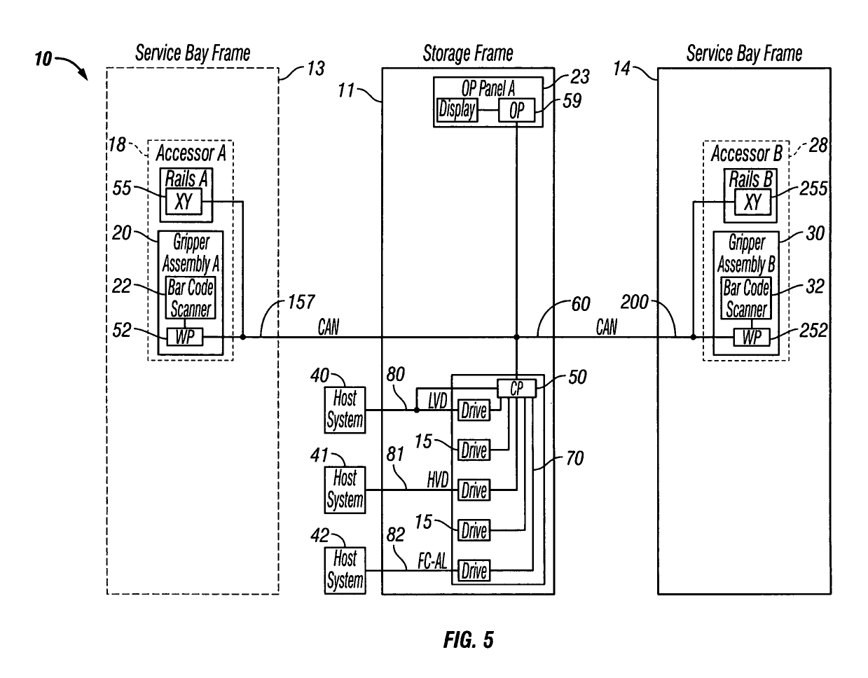

FIG. 5 illustrates an embodiment of an automated data storage library 10 of FIGS. 3 and 4, which employs a distributed system of modules with a plurality of processor nodes. An example of an automated data storage library which may implement the present invention is the IBM 3584 UltraScalable Tape Library. While the library 10 has been described as a distributed control system, this invention applies equally to libraries that incorporate other control configurations such as one or more library controllers that are not distributed. The library of FIG. 5 comprises one or more storage frames 11, a left hand service bay 13 and a right hand service bay 14.

The left hand service bay 13 is shown with a first accessor 18. As discussed above, the first accessor 18 comprises a gripper assembly 20 and may include a reading system 22 to “read” or “write” identifying information about the data storage media, for example, to a cartridge memory. The right hand service bay 14 is shown with a second accessor 28. The second accessor 28 comprises a gripper assembly 30 and may include a reading system 32 to “read” or “write” identifying information about the data storage media, for example, to a cartridge memory. In the event of a failure or other unavailability of the first accessor 18, or its gripper 20, etc., the second accessor 28 may perform all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14. In addition, the present invention may operate with fewer or more than two accessors.

In the exemplary library, first accessor 18 and second accessor 28 move their grippers in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41, 42 or for example, hosts 61-65 shown in FIG. 1. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18 and that is coupled to the communication processor node 50 via a network 60, 157. A second work processor node 252 that may be located at second accessor 28 and that is coupled to the communication processor node 50 via a network 60, 200 may also be provided. Each work processor node may respond to received commands that are broadcast to the work processor nodes from any communication processor node, and the work processor node may also direct the operation of first accessor 18, providing move commands. An XY processor node 55 may be provided and may be located at an XY system of first accessor 18. The XY processor node 55 is coupled to the network 60, 157, and is responsive to the move commands, operating the XY system to position the gripper 20. XY processor node 255 may also be provided and may be located at an XY system of second accessor 28. The XY processor node 255 is coupled to the network 60, 200, and is responsive to the move commands, operating the XY system to position the gripper 30.

Also, an operator panel processor node 59 may be provided at the optional operator panel 23 for providing an interface for communicating between the operator panel and the communication processor node 50, the work processor node 52, and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the host(s) and with the data storage drives. In the example of FIG. 5, host connections 80 and 81 are SCSI busses. Bus 82 comprises an example of a Fibre Channel-Arbitrated Loop which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

In FIG. 5 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

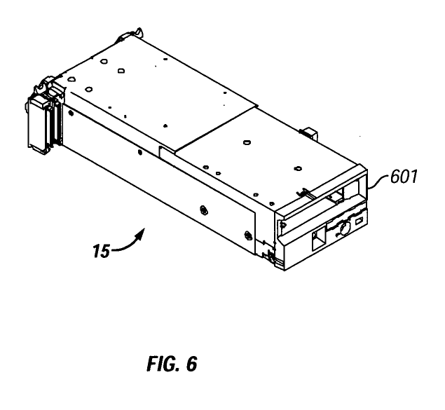

FIG. 6 shows a view of the front 501 of drive 15. In this example, drive 15 is a removable media LTO (Linear Tape Open) tape drive mounted in a drive canister. The drive canister may comprise a housing to hold drive 15, mounting means to attach drive 15 to the drive canister, electrical components, interface cables, interface connectors, etc. The data storage drive of this invention may comprise any removable media drive such as magnetic or optical tape drives, magnetic or optical disk drives, electronic media drives, or any other removable media drive as is known in the art.

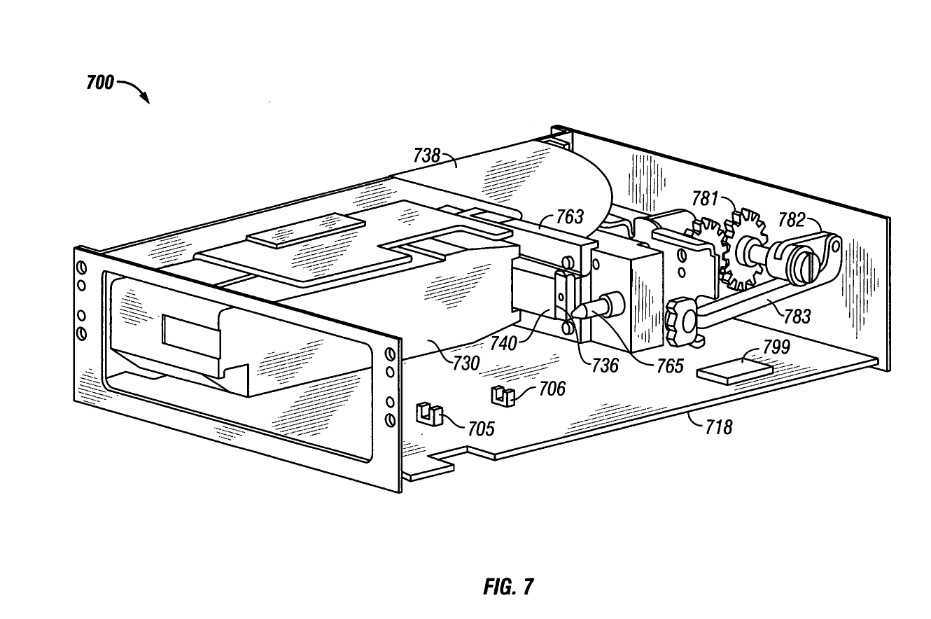

The present invention may be used for many different types of removable storage media, for example, magnetic tape media, optical media, hard disk drive media, etc. Herein the descriptors removable storage media, removable media cartridge, and removable media may be used interchangeable to refer to removable storage media. In the preferred embodiment and with reference to FIG. 7, drive 15 is implemented by docking station apparatus 700. Docking station apparatus 700 accepts removable storage media 730 with the rotation of bell crank 782 by gear train 781 which pulls the compliant links 783 toward the rear of cartridge docking station apparatus 700. This motion of compliant link 783 pulls removable media cartridge 730 normal to exposed electrical connections 740 of flexible cable 738, which rest on flexible substrate 736. First, the alignment pin 765 engages a corresponding hole (not shown) in removable media cartridge 730 to orient the removable media cartridge 730 and gradually laterally align a corresponding connector on removable media cartridge 730 with exposed electrical connections 740. This action establishes power to removable media cartridge 730 and bi-directional communication between removable media cartridge 730 and docking station 700. Flexible substrate 736 is supported by stiff substrate 763. The presence of removable media 730 is detected in docking station 700 via sensors 705 and 706. Printed circuit board 718 contains nonvolatile memory 799 for the storage of microcode. Nonvolatile memory 799 is preferably an EEPROM, but may be a battery backed-up RAM.

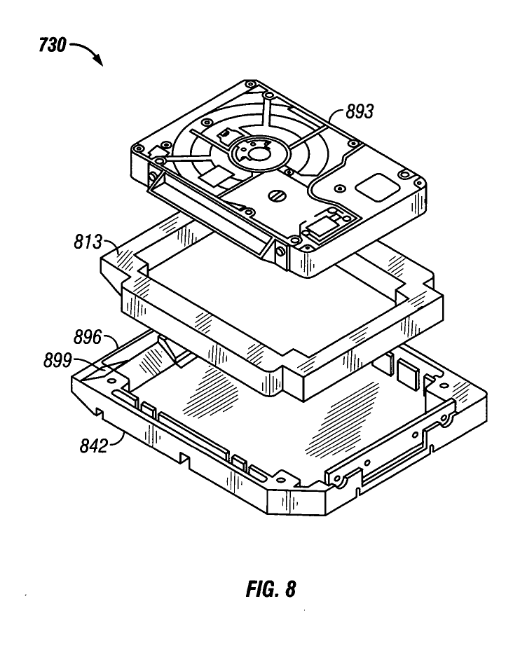

Referring to FIG. 8, a removable media cartridge 730 is provided having a cartridge shell 896 for storing a device, such as a data storage device. Such portable cartridges have been employed for the storage of data on a length of magnetic tape. In the preferred embodiment, an encased, self-contained magnetic disk drive assembly 893 may be mounted in such a cartridge. As discussed above, such removable media cartridges may be stored in automated data storage library 10, or handled manually. In handling the cartridges, robotic accessors, of automated data storage libraries occasionally drop a cartridge, or misplace a cartridge such that it is handled roughly, and manual handling is also likely to result in an occasional dropped or roughly handled cartridge. However, the typical data storage drive is not designed to accommodate that level of rough handling. As an example, a magnetic disk drive assembly that is available for use with a portable computer, is typically encased to prevent debris from getting into the assembly, and is preferably self-contained and operational, comprising both the necessary mechanical and electronic components. In this context, the assembly comprises at least one rotatable disk, a motor for rotating the disk(s), at least one head, an actuator and servo system for seeking and tracking, and addressing, motor control, and data handling electronics for reading and writing data, and for communicating at the data transfer interface, for example, employing an industry standard format, such as IDE, ATA, SCSI, or PCI.

The height dimension, comprising the stack of heads, one or more disks, and the disk motor, is typically the most critical, such that there is no room for a support structure for the cover over the disks and heads. Any force exerted on the cover has the possibility of causing the cover to deflect inwardly such that it may contact a head or disk, destroying or causing damage to the disk drive. A breathing hole is typically provided to prevent variations in atmospheric pressure from deflecting to cover. An organic filter and a desiccant may be provided on the inside of the hole for filtering debris and contaminates. As the result, although shock absorption is necessary, the cover comprises a sensitive surface which is unable to support a shock absorbing structure. Similarly, the typical magnetic disk drive assembly has a PCB (printed circuit board) at the bottom surface, which also comprises a sensitive surface that is unable to support a shock absorbing structure without deflecting and damaging the drive. Further, such sensitive surfaces may be unable to come into contact with a shock absorbing structure without causing damage to the disk drive, and certainly would be unable to come into contact with the cartridge shell, for example, through slippage within the shock mount, without causing damage to the disk drive.

FIG. 8 comprises an exploded view of an example of removable media cartridge 730, and contains, as an example, an encased, self-contained and operational magnetic data storage drive 893. An example of an encased, self contained, magnetic data storage drive of the desired form factor to fit within the cartridge shell 896 comprises a 2.5 inch series of magnetic data storage drives. FIG. 8 illustrates the bottom half 842 of the cartridge shell 896. Optional shock absorbing foam 813 or another shock absorbing material may be used to protect drive 893 from shock and vibration, such as being accidentally dropped by an accessor of automated data storage library 10.

Although the preferred embodiment is described with reference to automated data storage library 10, removable media cartridge 730 and docking station 700, the present invention is intended to apply to other types of data storage drives, removable media, removable media cartridges, without limitation. Also alternative data storage systems other than automated data storage library 10, for example, a personal computer, computing device, etc. may be used to implement the present invention.

Library controller 100 may comprise a dedicated controller of a prior art library or it may comprise a processor node of a distributed control library, such as the library of FIG. 5. For example, in FIG. 5, library controller 100 comprises communication processor (CP) node 50, work processor (WP) node 52, XY motion processor node 55, etc. In addition, library controller 100 may comprise more than one processor node, such as a distributed control library that employs multiple processor nodes to accomplish library functionality. Herein, library controller may comprise a single controller or multiple controllers or processors.

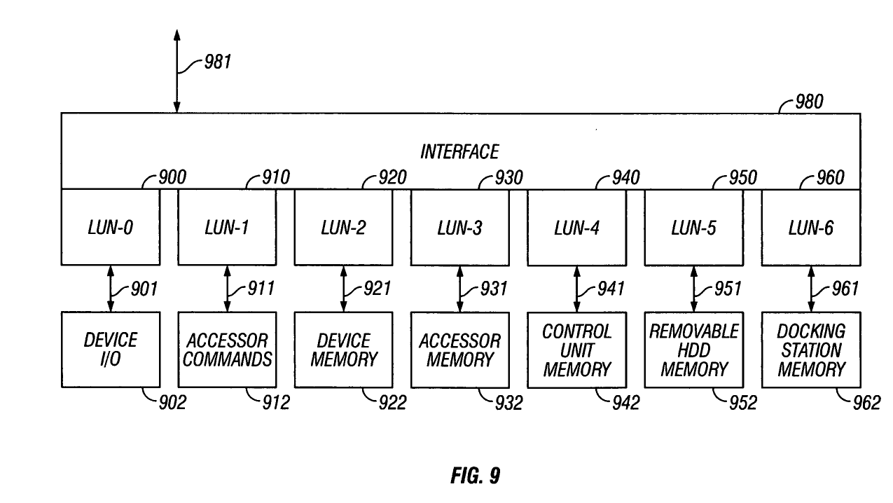

FIG. 9 shows link 981 in communication with interface 980. Link 981 represents any of links 76-78 shown in FIG. 1. Interface 980 represents any of interfaces 90, 92, 94 or 96. Interface 980 is compatible with link 981 and is preferably SCSI, iSCSI or Fibre Channel which supports SCSI. In this example, Interface 980 comprises LUNs 900, 910, 920, 930, 940, 950, and 960. Any of host(s) 61-65 may access interface 980 using a SCSI address and then access any of destinations 902, 912, 922, 932, 942, 952 and 962 using the corresponding LUN address 900, 910, 920, 930, 940, 950, or 960. The result is that interface 980 is coupled to host(s) 61-65 and is a device interface for any of the LUN addressable components (i.e. devices 902, 912, 922, 932, 942, 952 and 962). Interface 980 receives commands from any host and transfers the commands to the LUN addressable components.

LUN 900 is used for data device I/O 902 using link 901 for communication. Data device I/O (input/output) may comprise reading and writing data, data verification, etc. LUN 910 is used for accessor commands 912 using link 911 for communication. LUN 900 is typically LUN-0 and LUN 910 is typically LUN-1 of interface 980. Use of LUN 900 for data I/O and LUN 910 for accessor commands is known in the art and disclosed in U.S. Pat. No. 6,434,090. Use of LUNs 920, 930, 940, 950 and 960 for microcode updates constitutes one embodiment the present invention.

LUN-2 920 may be used by a host(s) 61-65 to update the microcode by addressing device memory 922 using link 921. Device memory 922 is preferably EEPROM. Device memory 922 is resident in the device, such as drive 15 shown in FIG. 6. A sequence of commands may be sent by any of host(s) 61-65 to accomplish the microcode update of any device using a LUN address. To update the microcode of drive 15 it may be necessary for a host to send a command to drive 15 to place it in an operational state to accept the microcode update. For example, all data storage operations in progress may be completed, no new data storage operations may be accepted, the data storage media may be removed from the drive and the drive may be placed in a special operational mode to accept the microcode update. The microcode update may then be sent by a host to LUN-2. The microcode update may directly overwrite all or part of device memory 922. Special commands may also be sent to LUN-2 to prepare device memory 922 for the microcode update. After the microcode update is complete, special commands may need to be sent to drive 15 by a host to perform a test to ensure that the microcode update was successful and begin normal operation of drive 15.

LUN-3 930 may be used by a host(s) 61-65 to update the microcode of accessor memory 932 using link 931 in a similar manner as described above for LUN-2 920. Accessor memory 932 is preferably EEPROM, however other types of memory may be used without limitation. Accessor memory 932 may be located on either accessor (accessor 18, accessor 28) or both, may be a portion of the memory for library 98, for example, nonvolatile memory 104 shown in FIG. 2, or other memory associated with library 98. The same procedures described above for LUN-2 920 may be used, for example, a sequence of commands may be sent by any of host(s) 61-65 to accomplish the microcode update, etc. The microcode update may be sent by a host to LUN-3 930. The microcode update may directly overwrite all or part of accessor memory 932. Special commands may also be sent to LUN-3 930 to prepare accessor memory 932 for the microcode update. After the microcode update is complete, special commands may need to be sent to the respective assessor by a host to perform test to ensure the microcode update was successful and begin normal operation of the accessor.

LUN-4 940 may be used by a host(s) 61-65 to update the microcode of control unit memory 942 using link 941 in a similar manner as described above for LUN-2 920 and LUN-3 930. Control unit memory 942 is preferably EEPROM, however other types of memory may be used without limitation. Control unit memory 942 may be a portion of the memory for library 98, for example, nonvolatile memory 104 shown in FIG. 2, or other memory associated with library 98. The same procedures described above for LUN-2 920 may be used, for example, a sequence of commands may be sent by any of host(s) 61-65 to accomplish the microcode update, etc. The microcode update may be sent by a host to LUN-4 940. The microcode update may directly overwrite all or part of control unit memory 942. Special commands may also be sent to LUN-4 940 to prepare control unit memory 942 for the microcode update. After the microcode update is complete, special commands may need to be sent to library 98 by a host to perform a test to ensure the microcode update was successful and begin normal operation of library 98.

LUN-5 950 may be used by a host(s) 61-65 to update the microcode of removable HDD memory 952 using link 951 in a similar manner as described above for LUN-2 920 and LUN-3 930. Removable HDD memory 952 is preferably EEPROM, however other types of memory may be used without limitation. Removable HDD memory 952 may be resident in hard disk drive 893 of removable media 730, shown in FIG. 8 or other memory associated with removable media 730. The same procedures described above for LUN-2 920 may be used, for example, a sequence of commands may be sent by any of host(s) 61-65 to accomplish the microcode update, etc. The microcode update may be sent by a host to LUN-5 950. The microcode update may directly overwrite all or part of removable HDD memory 952. Special commands may also be sent to LUN-5 950 to prepare control unit memory 952 for the microcode update. After the microcode update is complete, special commands may need to be sent to hard disk drive 893 of removable media 730 by a host to perform a test to ensure the microcode update was successful and begin normal of hard disk drive 893 or removable media 730.

LUN-6 960 may be used by a host(s) 61-65 to update the microcode of docking station memory 962 using link 961 in a similar manner as described above for the other LUNs. Docking station memory 962 is preferably EEPROM, however other types of memory may be used without limitation. Docking station memory 962 may be resident in docking station 700, for example, nonvolatile memory 799 shown in FIG. 7 or other memory associated with docking station memory 962. The same procedures described above for LUN-2 920 may be used, for example, a sequence of commands may be sent by any of host(s) 61-65 to accomplish the microcode update, etc. The microcode update may be sent by a host to LUN-6 960. The microcode update may directly overwrite all or part of Docking station memory 962. Special commands may also be sent to LUN-6 960 to prepare docking station memory 962 for the microcode update. After the microcode update is complete, special commands may need to be sent to docking station 700 by a host to perform a test to ensure the microcode update was successful and begin normal of docking station 700.

Each of the microcode update procedures described above may be necessary to update the memory of the respective hardware for increased function, increased performance, or to resolve a field problem. By using dedicated LUNs for the intended destination of the microcode update, an errant update of the wrong memory cannot occur. For example, it could be catastrophic to mistakenly load the microcode update intended for accessor memory 932 into device memory 922. Such an error could entirely disable library 98. The use of dedicated LUNs to pass microcode updates from the host to the destination of the update is positively accomplished by this embodiment. Microcode updates to more devices than described above may be accomplished by use of the present invention.

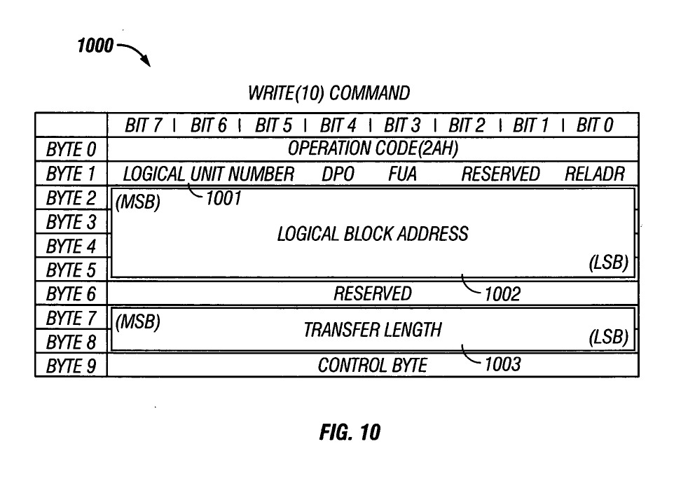

FIG. 10 shows exemplary SCSI write command 1000 that may be used to write the microcode updates to the respective memory device. The Logical Unit Number 1001 designates the target LUN for this write command. Logical Block Address 1002 designates the starting address of the information to be written, and Transfer Length 1003 designates the amount of information to be written. Thus, SCSI write command 1000 has all of the components to designate the writing of microcode of a known transfer length to a predetermined memory address using a dedicated LUN.

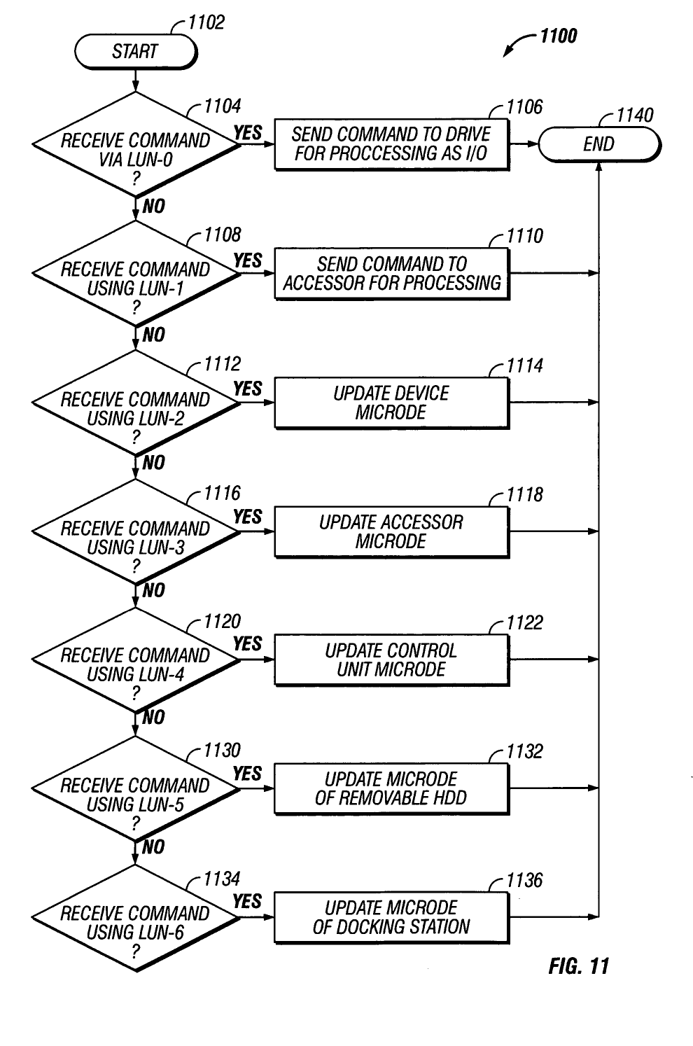

FIG. 11 shows flowchart 1100 of a process for the operation of one embodiment of the present invention. The direction of information transfer depends upon the LUN designated in SCSI write command 1000. For this example, a first LUN is assigned to a device and a second LUN is assigned to a memory. Additional LUNs may be assigned to additional devices and memories. The device receives commands from a host and obtains the LUN address from the command. If the LUN address of the received command is the second LUN then the commands are processed to update the microcode in the memory. If the LUN address of the received command is the first LUN then the commands are processed as I/O (input/output) commands for the device. A portion of the commands received by the device at the first LUN may be commands to place the device in an operational state to receive the microcode update. For example, the device may complete the processing of all current commands and not accept new commands. All movable components, for example, disk drives, accessors, etc. in an automated data storage library may be placed in a rest or home position before the microcode update begins. The microcode memory may be updated by overwriting all or a portion of the memory that comprises the microcode for the device. As shown in the following example there may be more than one device. For example a second device removeably attached to the first device with the memory coupled to the first device may be used with the present invention. Beginning at step 1102, the process flows to decision step 1104, where the query is made whether a command was received using LUN-0. If a command was received using LUN-0, the process flows to step 1106, where the command is sent to the drive 15 or 893 for processing as I/O. If a command was received not using LUN-0, the process flows to decision step 1108, where the query is made whether a command was received using LUN-1. If a command was received using LUN-1, the process flows to step 1110, where the command is sent to either accessor 18 or accessor 28 for processing as an accessor activity command.

If the result is “no” at step 1108, the process flows to decision step 1112, where a query is made whether a command was received using LUN-2. If a command was received using LUN-2, the process flows to step 1114, where the microcode update is sent to the nonvolatile memory of device 15. There may also be separate commands issued by a host(s) to prepare for the microcode update as explained above. If the result is “no” at step 1112, the process flows to decision step 1116, where the query is made whether a command was received using LUN-3. If a command was received using LUN-3, the process flows to step 1118, where the microcode update is sent to the nonvolatile memory of accessor 18. There may also be separate commands issued by a host(s) to prepare for the microcode update as explained above. If the result is “no” in step 1116, the process flows to decision step 1120, where the query is made whether a command was received using LUN-4. If a command was received using LUN-4, the process flows to step 1122, where the microcode update is sent to the nonvolatile memory 104 of controller 100. There may also be separate commands issued by a host(s) to prepare for the microcode update as explained above. If the result is “no” in step 1120, the process flows to decision step 1130, where the query is made whether a command was received using LUN-5. If a command was received using LUN-5, the process flows to step 1132, where the microcode update is sent to the nonvolatile memory of removable hard disk drive 893. There may also be separate commands issued by a host(s) to prepare for the microcode update as explained above. If the result is “no” at step 1130, the process flows to decision step 1134, where a query is made whether a command was received using LUN-6. If a command was received using LUN-6, the process flows to step 1136, where the microcode update is sent to the nonvolatile memory 799 of docking station 700. If the result is “no” at step 1134, the process ends at step 1140, where the device receiving the microcode update may reboot to enable the device to begin operation with the microcode update. Steps 1106, 1110, 1114, 1118, 1122, 1132, and 1136 all end at step 1140 after their respective completion. Upon completion of the microcode update of any device using any LUN, host(s) 61-65 may issue commands to verify that the microcode has loaded correctly, perform operational tests, etc., and begin normal operation of the respective device.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Obviously many modifications and variations are possible in view of the above teachings.

The invention disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A method for updating microcode, comprising the steps of:
assigning a first LUN to a first device;
assigning a second LUN to a memory;
said first device receiving one or more commands;
said first device obtaining a LUN address from each of said one or more commands; and
in response to said LUN address obtained from each of said one or more commands being equal to said second LUN, processing each of said one or more commands to update said microcode in said memory.

2. The method of claim 1, further comprising:
in response to said LUN address obtained from each of said one or more commands being equal to said first LUN, processing each of said one or more commands as input/output commands of said first device.

3. The method of claim 1, further comprising:
in response to said first device receiving a prepare for microcode update command, placing said first device is a operational state to receive said update of said microcode.

4. The method of claim 3, wherein said placing said first device is a operational state to receive said update of said microcode further comprises:
not accepting any new commands for processing;
completing all current commands; and
placing movable components at a rest position.

5. The method of claim 1, wherein said processing each of said one or more commands to update said microcode further comprises:
overwriting a memory associated with said first device with an updated microcode.

6. A system for updating microcode, comprising:
a first device addressable by a first LUN; and
a memory addressable by a second LUN, wherein said first device receives one or more commands, obtains a LUN address from each of said one or more commands and in response to said LUN address obtained from each of said one or more commands being equal to said second LUN, processing each of said one or more commands to update said microcode in said memory.

7. The system of claim 6, further comprising:
a host, wherein said host sends microcode update commands to said first device.

8. The system of claim 6, further comprising:
a host; and
a device interface coupled to said host, wherein said device interface receives commands from said host and transfers said commands to LUN addressable components.

9. The system of claim 6, wherein said memory is an Electrically Erasable Programmable Read Only Memory.

10. The system of claim 6, wherein said memory is coupled to said first device.

11. The system of claim 6, further comprising
an accessor, wherein said memory is coupled to said accessor.

12. The system of claim 6, further comprising:
a second device removably attached to said first device, wherein said memory is coupled to said second device.

13. The system of claim 6, further comprising:
a controller for operating said first device, wherein said memory is coupled to said controller.

14. The system of claim 6, wherein said system is an automated data storage library.

15. An article of manufacture comprising a data storage medium tangibly embodying a program of machine-readable instructions executable by a digital processing apparatus to perform method steps for updating microcode of a first device assigned to a first LUN, said first device coupled to a memory assigned to a second LUN, said method comprising the steps of:
said first device receiving one or more commands;
said first device obtaining a LUN address from each of said one or more commands; and
in response to said LUN address obtained from each of said one or more commands being equal to said second LUN, processing each of said one or more commands to update said microcode in said memory.

16. The article of manufacture of claim 15, wherein said method further comprises:
in response to said LUN address obtained from each of said one or more commands being equal to said first LUN, processing each of said one or more commands as input/output commands of said first device.

17. The article of manufacture of claim 15, wherein said method further comprises:
in response to said first device receiving a prepare for microcode update command, placing said first device is a operational state to receive said update of said microcode.

18. The article of manufacture of claim 17, wherein said wherein said placing said first device is a operational state to receive said update of said microcode further comprises:
not accepting any new commands for processing;
completing all current commands; and
placing movable components at a rest position.
